(19) United States
(12) Patent Application Publication
(10) Pub. No.: US 2023/0008379 A1
(43) Pub. Date: Jan. 12, 2023

(54) Travel Management System

(71) Applicant: Disrupt Industries AS, Oslo (NO)

(72) Inventors: Tomas Are Haavet, Oslo (NO); Roy Golden, Oslo (NO); Dennis Tönnkvist, Oslo (NO)

(21) Appl. No.: 17/368,886

(22) Filed: Jul. 7, 2021

(51) Int. Cl. G06Q 10/02; G06Q 20/12; G06Q 50/14

(52) U.S. Cl. CPC G06Q 10/025; G06Q 20/12; G06Q 50/14

(57) ABSTRACT

Described herein is a travel management system configured to: accept, as input, selected dates for the start and end of a leisure portion of a trip and the start and end of a business portion of a trip; accept, as input, service data for each of one or more services; for each of the one or more services, access an associated rule set and conduct a first availability search based on the service data in respect of a first pair of the input dates that is selected based on instructions in the rule set; and select one or more of the results of the first availability search for display to a user.

### BACKGROUND

The present invention relates to a management system, and in particular to a combined event management system, a travel management or travel booking system, such as a system for booking flights, hotels, and other services for a combined leisure and business trip.

The way in which people work is changing, and part of this change relates to where employees are located during a typical working day or week. Employers are increasingly required to be flexible on this point, and to facilitate employees working from home or elsewhere outside of an ordinary office environment. This comes partly as a result of the recent global pandemic and the resulting restrictions placed on employers and employees, which have put additional barriers in the way of traditional office work. This trend is very likely to continue to develop to include the possibility of not only working from home, but of working from abroad and/or combining leisure travel with work to a greater extent than is currently possible. In addition, younger employees place increasing value on the possibility of travelling as part of their working life.

Travelling to attend work meetings, conferences, or for other reasons connected to work, will often mean that flights and hotels are paid for by the company, however a large proportion of these trips are extended because the employee chooses to combine their business trip with a leisure stay. This allows them to save money and travel time, and to take the opportunity to explore a new location that they may otherwise not have had the chance to see.

Some companies do provide or endorse third party booking platforms for booking business trips, and these can be tailored to company policy to an extent, for example to exclude the possibility of booking business class flights for short-haul trips, and so on. The employee can book travel and hotels for their business trips through this platform, and can have these paid for by the company. Things become complicated, however, when the employee wishes to extend their trip for leisure purposes. This is especially true when additional travellers are to be included, such as family members joining for the leisure portion of the trip only.

Travel booking platforms have seen little fundamental change over the past 20 years, and any adaption has been largely related to the appearance of the graphical interfaces provided. The same input fields and filters are used, and separate booking processes are required to search, select, and book each of a number of services such as hotels, cars, flights, activities, and so on. Although some platforms now allow flights and hotels to be booked simultaneously, a user planning to travel for work and then stay on in their destination city for a time must go through lengthy processes, sometimes on a number of different platforms, in order to book both portions of the trip.

Traditionally, including an additional leisure stay at the start or end of a business trip requires the employee first to search both the flights they wish to take and the flights they would have taken if the leisure portion of their trip were not accounted for, take a snapshot of the latter results to send to HR, and pay the difference out of their own pocket. Hotel bookings will also consist of two separate searches and two separate booking processes for each of the leisure and business portions of the trip in order to be able to split the cost effectively. All of these searches must be initiated by the employee. In most cases, the platform provided by the company will not provide the desired choice and flexibility for the leisure stay, and the employee will move to other platforms which are specifically designed for this purpose in order to book the leisure portion of their trip.

Some corporations have defined company policies covering employee travel, which sometimes include a specific policy regarding return flights booked to include a leisure portion of an extended business trip, and how the difference in cost should be covered. The procedures include comparing the leisure flight to the business flight that the employee would have taken at the end or start of the business section of the trip (as mentioned above). This cost comparison and cost splitting process is handled manually. This manual process is typically done the employees taking screenshots of their business flights that they should have booked and the leisure flights that they would like to book, and sending these to the accounting department to validate the price difference with reference to the company policy. After the manual validation by accounting, the employee is charged for the price difference.

In other corporations, if the trip is booked outside of the company approved booking platform (e.g. via an OTA) and the trip is paid for using the employee’s personal credit card, then the employee will have to split the costs before expensing the business costs and show evidence of the price difference. Again, this will all need to be done by the employee and will require a manual approval process after expensing, with no possibility of approval prior to booking.

Several additional problems also arise when booking separate business and leisure portions of the same trip. Keeping track of the selected dates, hotels, room details, flights, and amenities during the course of at least two separate booking processes is difficult, particularly given the increasing number of different choices presented to the user in each case. In addition to keeping track of the previously selected options, the user needs to take into account the availability of the different options in each of the relevant periods. If they have already booked or purchased a hotel room for the business section of the trip, for example, there is no guarantee that this same hotel will be available at a later stage when the user comes to book the leisure portion of his or her stay.

The need to run through multiple separate booking processes (and in some cases return to a first booking process to select a different hotel) can potentially result in a lot of time spent in total, which makes it more likely for mistakes to be made. Since surveys show that when booking for business and leisure combined employees generally book both portions of the stay during working hours, businesses can experience a drop in productivity as a result of this.

US16/113,472 describes a hotel booking platform which uses a corporate policy to encourage employees to select cheaper options. The search results, which may be sourced from a variety of online search services or travel agents, are ordered based on how far below a target price they come. Rewards or incentives are offered to the employee for options which fall below the target. US-A-2017/0132716 also relates to corporate travel booking systems.

### SUMMARY

According to a first aspect of the present invention, there is provided a travel management system configured to: accept as input selected dates for the start and end of a leisure portion of a trip and the start and end of a business portion of a trip; accept as input service data for each of one or more services; for each of the one or more services, access an associated rule set and conduct a first availability search based on the service data in respect of a first pair of the input dates selected based on the rule set; and select one or more of the results of the first availability search in respect of that service for display to a user.

If the business portion of the trip is first, and the two portions of the trip do not overlap, then providing an end date for the business portion will also provide a start date for the leisure portion of the trip and this may only need to be entered once, with the information that the trip portions do not overlap. The leisure and business dates are generally entered into the system by the user in response to a prompt. The same is true of the start date for the business trip/end date of the leisure trip where the leisure portion is first. If additional travellers are to join, then the business and leisure trips may in some cases be able to overlap for one or more of the additional travellers. The input may comprise a start date and duration for each portion of the trip (or an end date and duration), in which case the end date for each portion can be inferred by the system and is therefore also provided. The fact that the searches are referred to as a “first” and “second” search does not mean that they must be carried out in that particular time order. The searches can be carried out simultaneously, or the second availability search can be carried out before the first availability search, or vice versa. If either portion of the trip is only one day long the start and end dates for that portion may be the same.

Both the dates for the leisure portion and the dates for the business portion can be added at the same time using the same input screen (e.g. a single click of the bottom provides input regarding both pairs of dates). The dates can be entered using a screen displaying a calendar, for example, where the user is asked to highlight separately the dates of the business portion of the trip and the dates of the leisure portion and then click a confirmation icon to input the data.

Where more than one service can be booked through the platform, a separate rule set will be present in respect of each service (where the platform allows flights and hotels to be booked, for example, a flight rule set and a hotel rule set will be accessible by the system, and may be saved in external or internal data storage). In most cases, these rule sets tell the system both which pair or pairs of the input dates need to be searched and when, as well as how to use the results of the searches, i.e. how to combine the results of two separate searches in respect of the two separate portions of the trip and which of the separate or combined results should be displayed to the user or highlighted to the user. Where a second availability search is carried out, searches in respect of two distinct pairs of dates, which in some cases will correspond to the business and leisure parts of the trip respectively, may be carried out without the requirement of input, or of further input, from the user. These searches may be carried out simultaneously.

The travel management system greatly simplifies the process of booking a combined trip for the user. This will encourage use of a company endorsed platform, and of a single platform for booking. The system can also be simply integrated with a company’s accounting software to enable quick payment during the booking process. The system is able to handle search and booking requests for both business purpose and leisure simultaneously, and the process includes one single booking and purchase transaction for the user, which is a great benefit compared to previous systems.

In embodiments, the results to be displayed are selected according to instructions in the rule set.

In embodiments, the travel management system is configured to accept personal input data for each of one or more persons.

In embodiments, the service data comprises service type, and optionally at least one of service place, service owner, and service share information.

In embodiments, the service type is one of transport, accommodation, and “event”; the service place is a combined departure and destination, a departure and multiple destinations for a multi-stop trip, or one or more “locations”; the service owner is person, a group or a company, and the service share information is a specification of other of the one or more persons with whom the service should be shared.

In embodiments, at least a subset of the service data is selected commonly for more than one of the one or more persons.

In embodiments, the travel management system is configured to perform a second availability search in respect of a second one of the input dates or a second pair of the input dates selected based on instructions in the rule set. In embodiments, at least one of the second pair of input dates is different from the first pair of input dates and/or the second one of the input dates is different from the input dates in the first pair.

In embodiments, the input is a user input. In embodiments, the user input is input to an input screen. The input screen may be a display screen. The user input may be provided in any way, including by providing voice instructions, typing into a text field on the input screen, use of a chatbot, and so on.

In embodiments, the input is a system input. The system input may be made via an API, or may use any other system related process initiation method. The input may be via a third-party solution utilizing an API, such as a company HR system or a phone application, from which the relevant dates can be input to the system to begin the initial search stage. The system can be linked to a user’s calendar, for example, in which case an entry in the calendar that a combined business and leisure trip will take place may trigger an input to the travel management system to book flights and hotels. If leisure and business dates are both added in the calendar, this information can be sourced as input to the travel management system as described above. The information regarding the service may be input from a user specific or general profile in which some information is stored regarding the type of services that user or type of user will require.

In embodiments, the input comprises a departure location and a destination location. The departure and destination locations may be provided as countries, cities, addresses, airports, map locations, etc. The input may comprise one or a set of departure and destination locations, for example in the case of a multi-stop trip. For a multi-stop trip, the dates when the employee and or additional travellers intend to travel between the different locations should also usually be entered as part of the initial input.

In embodiments, the first pair of dates are the start and end dates of the combined trip or the start and end dates of the leisure portion of the trip, and the second pair of dates are the start and end dates of the business portion of the trip.

In embodiments, the rule set comprises an instruction to compare the results of the two availability searches and to select and display or highlight only those results which are present in both. Highlighting refers to the fact that more or all of the results are displayed, but those in both sets are marked in some way to indicate this to the user. As an example, this is used to guide or help the user to select the same flights for the legs of the trip that are in common between the leisure and the business travellers.

In embodiments, the first pair of input dates are the start and end dates of the leisure portion of the trip and the second pair of input dates are the start and end dates of the business portion of the trip, and the results displayed include the results of both searches. In embodiments, the system is configured to accept as input the selection of one or more of the results displayed after the search stage, and to carry out one or more bookings relating to the leisure portion of the trip, and one or more bookings relating to the business portion of the trip in response to a single booking confirmation input, or one single booking covering the leisure and business portion of the trip in response to a single booking confirmation input. The first availability search can therefore relate to the leisure portion of the trip and the second availability search relates to the business portion of the trip, and the results displayed include the results of both searches.

The bookings are therefore carried out without a booking confirmation being required for each of the separate bookings. The results displayed at the end of the search stage, in which multiple searches may be carried out behind the scenes according to the rule set for each of a number of different services (e.g. including flight and accommodation), can include multiple options for the leisure and business trips, as well as options for additional travellers if present. Once a selection of the desired options has been input, for example by the user themselves or automatically according to a stored rule set, the booking stage will be initiated. This booking stage will include multiple bookings relating to both the business and leisure portions of the trip. The bookings do not require any separate confirmation from the user or an external source to execute, but are carried out behind the scenes by accessing the different third-party sites to confirm bookings (i.e. a flight booking for each traveller with an airline company and a hotel booking for each of the leisure and business legs with a hotel). The booking process appears as a single booking to the user, and requires only one booking confirmation as input, but involves multiple bookings behind the scenes by the system itself.

In embodiments, the one or more services comprises an accommodation service, the first availability search is a search for accommodation available during the leisure portion of the trip (the first pair of dates being the start and end dates of this portion) and the second availability search is a search for accommodation available during the business portion of the trip (the second pair of dates being the start and end dates of this portion). The first availability search may be for accommodation available during the part of the leisure portion which does not overlap with the business portion in a case where the two portions are overlapping. This allows business costs to take precedence during the cost-spitting process, since companies will usually agree to cover the costs of the whole business trip even if this overlaps in part with a leisure trip.

These searches may be carried out at the same time or consecutively. In embodiments, the accommodation is a hotel and the first and second availability searches are for hotels with one or more rooms available during the leisure and business portions of the trip respectively. The first and second availability searches may be for accommodation available during the entirety or the whole of the leisure and business portions of the trip respectively.

In embodiments, the one or more services comprise a transport service, the first availability search is a search for return transport with an outbound journey on the first day of the combined trip and a return journey on the last day of the combined trip, and optionally the second availability search is a search for return transport with an outbound journey on the first day of the business portion of the trip and a return journey on the last day of the business portion of the trip. The arrival airport, port, or station for the outbound journey may be the same as the departure journey for the inbound journey, or may be different in the case of a multi-city or multi-destination trip. The transport service may be a flight service and the outbound and inbound journeys may be flights.

In embodiments, the rule set comprises instructions to execute the first availability search and display one or more of the results of the first availability search to the user, to wait for selection of a result by the user, and to execute the second availability search only in respect of return transport which has one journey in common with the selected result.

In embodiments, the user input comprises the details of one or more additional travellers for the leisure portion, the system is configured to carry out a third availability search for return transport with an outbound journey on the first day of the leisure trip and a return journey on the last day of the leisure trip, and the transport rule set comprises instructions to display or highlight only the results of the first and third availability searches which include one journey in common.

Where the leisure portion is first, the last day of the leisure portion of the trip may be the same as the first day of the business portion of the trip, or may be before the last day of the business portion of the trip. Where the business portion is first, the first day of the leisure portion may be the same as the last day of the business portion or may be before the last day of the business portion. Alternatively, the additional travellers may arrive before the employee or may leave after the employee (although this will rarely be the case). One hotel room in the overlapping portion will generally be paid for by the company, and the rest will be payable by the employee (hotel rooms for additional guests, etc). In some cases, for example if a larger room is booked during the business stay to accommodate additional passengers during part of this period, or for convenience to book the same hotel room for the business and leisure periods, then this additional cost or a proportion of this additional cost may be covered by the employee. The system is operable to automatically separate these costs based on the results of the availability searches and company policy.

In embodiments, the system is configured to present a single payment confirmation screen displaying the separate costs of the business and leisure portions of the trip, including the cost of each of the one or more services, and at least one confirmation icon for confirming payment of the costs of one or more portions of the trip.

In embodiments, the system is configured to access cost policy information specifying a proportion of the leisure trip to be covered by the company, and to separately display a cost payable by the employee and a cost payable by the company for the combined trip on a single payment confirmation screen, and at least one confirmation icon for confirmation of payment of the portion payable by the employee and/or by the company.

The separate costs of the leisure and business portions can be calculated first, and optionally displayed for viewing by the user. The separate costs payable by the company and the employee can then be calculated based on these and the company policy information. If the employee should cover the whole of the leisure cost, then the business and leisure costs calculated are simply displayed separately as payable by the two different parties. If the company will cover a fixed percentage of the leisure costs, then the cost payable by the company will include the total cost for the business portion and a part of the cost of the leisure portion. The cost policy information can be tailored to a particular company, and can be updated as desired. Cost policy information associated with the or each company, or with a sub-section of a company such as a team, role, employee, or department, can be stored in an external or internal data storage. The cost policy information may be stored in an internal database comprising part of the system.

In embodiments, the payment confirmation screen comprises a single confirmation icon for confirming payment of both portions.

In embodiments, the rule sets for each of the one or more services are stored in a database comprised as part of the system.

In embodiments, the rule sets for each of the one or more services are updated based on a user input or based on previous selections made by the user.

In embodiments, the system is configured to edit or cancel one, more than one, or all of the services in respect of both the business portion and the leisure portion of the trip in response to a single user request to edit or cancel the service. The user does not need to separately edit or cancel the two trips as would be necessary for prior art systems. Only one single input, or single input action by the user, is required to edit or cancel both trips. If desired, the services in respect of the business or leisure portion can be edited or cancelled separately (i.e. one but not the other), but the option of editing or cancelling both with a single input remains, and this is not possible with prior art systems.

According to a second aspect of the present invention, there is provided a travel management system configured to: accept, as input, selected start and end dates for one or more portions of a trip; accept, as input, service data for each of one or more services; for each of the one or more services, conduct at least two availability searches based on the service data in respect of at least two respective pairs of the input dates; select one or more of the results of the at least two availability searches for display to a user; and based on selected results and in response to a single booking confirmation input, complete at least one booking in respect of the first pair of dates and at least one booking in respect of a second pair of dates, or at least one booking in respect of a single pair of the input dates. In embodiments, the first and second pairs of dates are different. The input may comprise selected start and end dates for at least two portions of a trip, or the start and end dates of the combined trip.

### BRIEF DESCRIPTION OF DRAWINGS

Embodiments of the present invention will now be described, by way of example only, with reference to the following diagrams wherein:

FIG. 1 is a diagram illustrating one example architecture for the system;

FIG. 2 illustrates a possible display screen for inputting business and leisure dates;

FIG. 3 shows the process flow for a hotel selection portion of the transaction;

FIG. 4 shows a process flow for a flight selection portion of the transaction;

FIG. 5 illustrates an example display screen for selecting flight options;

FIG. 6 shows a process flow at checkout; and

FIG. 7 illustrates how a display may appear to the user at checkout.

### DETAILED DESCRIPTION

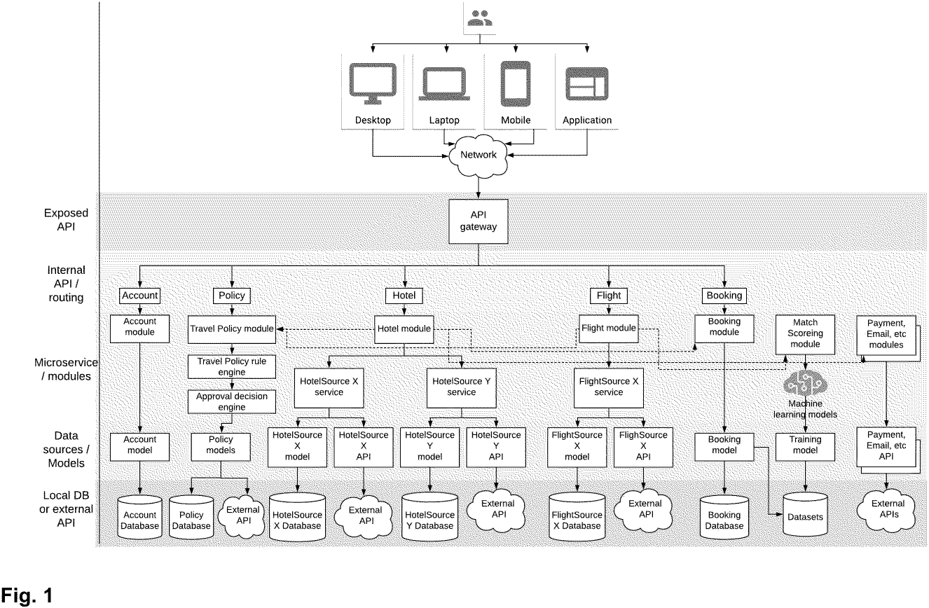

The platform described herein comprises a decoupled frontend and backend, which are connectable through an API, and a tech stack. The backend is usable by a number of different frontends through the API, and different frontends can be developed for use on mobile phones, computers, desktops, and other portable or non-portable devices. The backend itself may be decoupled according to the Microservice Architecture pattern. FIG. 1 illustrates one possible example of a backend architecture. The backend comprises multiple microservices and can be considered as split into four different levels as shown, each of which has a different function.

Although the following specific choices are not limiting and comprise just one example of how the architecture may be built, the architecture can comprise a frontend as mentioned above, which can be built on any suitable framework and written with any suitable language. The skilled person will be aware which particular frameworks and languages will be usable in this case. CSS-styled components may be used to avoid class name collisions, and data may be fetched from an API (backend) using any suitable client. The backend may be built using different environments and languages for each microservice. Relational databases, document databases, key value database, and network databases can be used for data persistence. Much of the overall search, selection, and payment process is carried out behind the scenes within the backend, with very little input or intervention required by the user.

The backend includes an upper layer for routing input from the API to the service layer of the backend, through which data relating to each of the separate services is sourced. The routing layer links through the backend to external databases and in some cases to external search engines, which are used to obtain results based on the various search terms. One or a plurality of databases and/or external search engines or services can be accessed during each search. The accessed databases relating to each of the separate services may be external to the platform, and may therefore be accessed through a third-party API. In some cases, the platform may comprise its own internal database listings relating to one or more of the services, and these may include the rule sets associated with each service. These may be present in addition to access to external search engines, databases, and platforms. The services may include separate accounting and payment services, as well as those relating to the different options for booking, such as flight, hotel, activities, restaurants, and so on. Any number of different services can be present as part of the architecture. In the example shown in FIG. 1, account, policy, hotel, flight, booking, match scoring, and payment/email services are present.

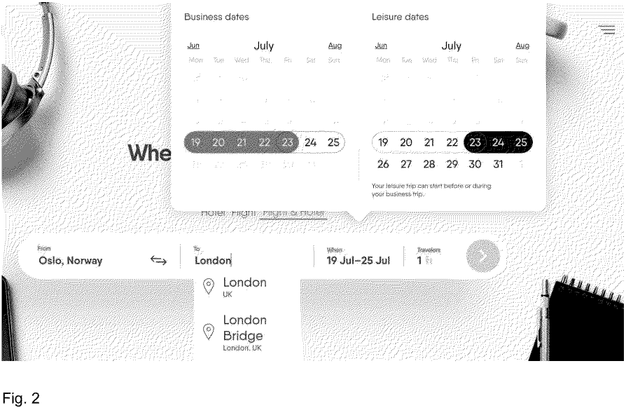

The way in which the data is input and processed means that a single screen or shared view can be provided to the user for selecting the search criteria for business or leisure or both. An example of this type of selection screen is shown in FIG. 2. In the simplest case, the user simply needs to select travel dates and destination using this input display screen.

The input data is then used to carry out the various linked searches as follows. For each service for which the user wishes to book, separate searches are carried out (generally for each of the business portion and leisure portion of the trip) and the results can in some cases be combined as will be described in more detail below. The searches may be carried out substantially immediately, i.e. they may directly follow input of the dates for the two portions of the trip, or one of the searches may be carried out later in the process to improve efficiency. The latter is generally done in the case of flight bookings by following instructions in the flight rule set, as will be described in more detail below.

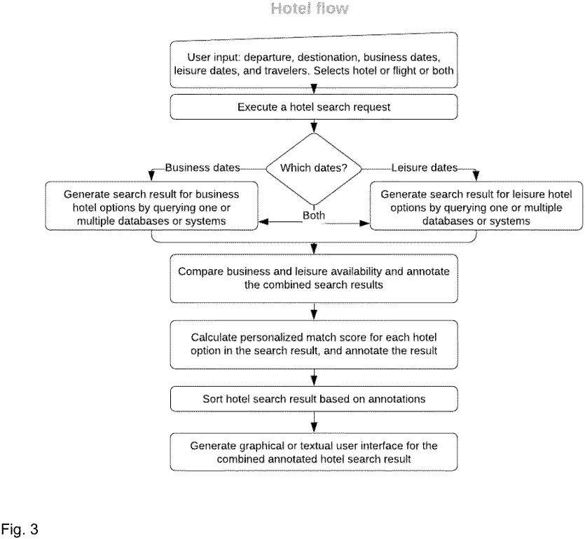

FIG. 3 illustrates the process in the specific example of a hotel booking process as carried out by the system. The user inputs their desired destination or destinations and the start and end dates for each of the business and leisure parts of their trip. They also specify how many will be travelling during each portion of the trip and whether these are adults or children (in most cases using a single screen to do so as in the example shown in FIG. 2). Additional information can be input using the same or a different display screen, such as preferences for a type or location of the hotel. These preferences can also be part of a user profile or can be learned by the system using machine learning, or other relevant algorithms and techniques, and can therefore be based at least partly on past selections.

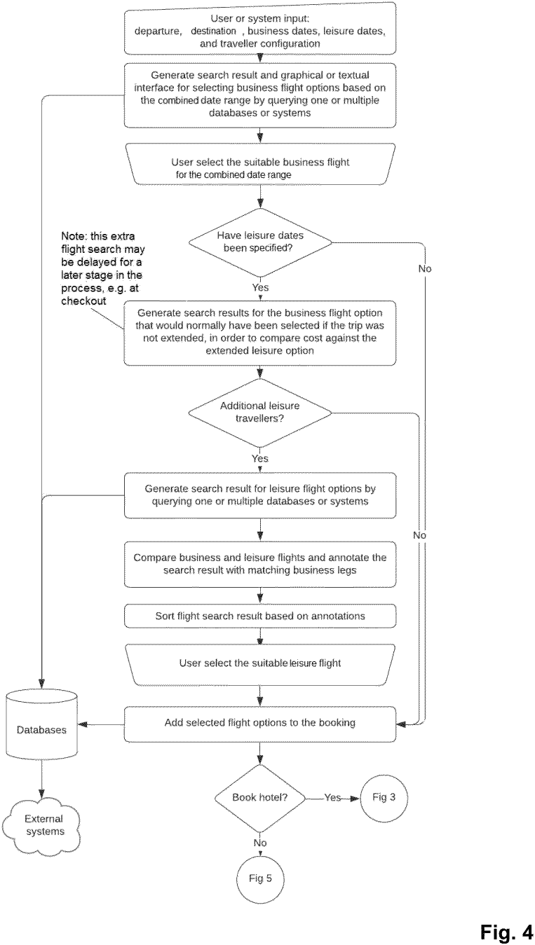

In other examples, where alternative services are being booked (such as flights, activities, and so on), different input options may be presented, but the start and end dates for the leisure and business portions of the trip will always be required as input. This information can be provided indirectly, however, by inputting a start date or end date and a duration of each portion of the trip, or by inputting a start date for one portion and specifying that this will be the same as the end date for the other portion. Obviously, the information can also be provided directly by inputting each of the dates. FIG. 4 illustrates a process flow in respect of a flight booking for a single destination trip, for example. The user inputs their dates, departure city and destination city, the number of passengers for each leg, and whether the passengers are adults or children, or infants. Separate searches are carried out in respect of the start and end dates for the combined trip (the employee’s travel), and the start and end dates of the leisure trip (the additional passenger or passengers’ travel). These may be compared and presented so that only results with one flight in common are shown, or the options available with a common flight are highlighted within a larger results set. The specific way in which the results are collated, which pairs of dates are selected for searching, and the point in the process at which each search is carried out, may depend on the type of service concerned and the associated rule set for that service.

Once the required information has been entered, the user confirms that the search should go ahead, and the system executes the searches. The user is required to confirm the search only once, and they will receive suitable results based on available options in both portions of the trip if applicable. In some cases, without further input from the user, the system executes two search requests, one in respect of the combined or leisure portion of the trip and one in respect of the business portion. These may query multiple databases behind the scenes to retrieve suitable results. The two portions of the trip may have different requirements associated, such as a different number of adults, different price limits, and so on. Once the results for the separate searches have been extracted, these may be collated in a comparison step to find options which are available during both portions of the trip or which have a journey in common, and which fit the requirements for both.

In the case of the hotel searches, the system assumes initially that the preference of the user is to stay in the same hotel (and the same hotel room) for both the business and leisure portions of the stay. To this end, results for the separate searches are generally compared to find options which are available for both portions of the stay, and only these options are displayed. The way in which the searches are carried out, however, does allow for different options to be selected for each leg. If an additional traveller who is the employee’s partner will join for the leisure portion, for example, the room may be upgraded from a single during the business portion to a double during the leisure portion. The displayed results will include hotels where a single room is available to cover the business dates as well as a double room to cover the leisure dates. Analysis shows that in around 80% of cases, travellers do wish to stay in the same hotel during both legs of the trip for convenience, however as an alternative, different requirements can be searched for each leg, so that different hotel selections can be made for each. The user profile can include information about which of the above search strategies will be followed. This may have been input previously or learned by the system, or the user can input this search strategy information as part of the booking process.

Once the searches have been completed by the system, the user will be presented with options representing available services corresponding to each portion of the trip. Because of the way the searches are carried out and the fact that these are linked, the results of the searches and/or the way in which these are presented or highlighted in respect of the business and leisure parts of the trip will be interdependent, which is in contrast to a traditional travel booking platform. The user also does not need to initiate the separate searches one at a time. Rather, the searches will either complete concurrently using input from the initial display screen, or at different times during the process if the user is required to select a result of one search before the next search is carried out.

The input can comprise a selection of departure and destination locations, traveling dates for each of the business and leisure portions of the trip, and the number and type of travellers present on each section of the trip (e.g 1 adult on the business section and an additional adult and 2 children on the leisure section).

The flight search result may present one or more combined flight offers (e.g. based on cabin class) with options to select the appropriate offer at the time of the first search result generation. FIG. 4 shows the process flow for flight bookings. This works similarly to the search process in respect of other services in that separate searches are requested and executed behind the scenes without separate input being required from the user. The flight booking process is also required to provide the necessary information to split flight costs accurately between leisure and business sections of the trip, however, and this requires information to be accessed and stored regarding the cost of flights back home on the date on which the business trip is due to end (or outbound flights on the date on which the business flight is due to start if the leisure trip is to take place first).

When the user requests a search for available flights based on their input business and leisure dates, searches are undertaken for outbound flights at the start of the combined trip, incoming flights at the end of the combined trip, and theoretical incoming flights at the end of the business trip where the business leg is first or theoretical outgoing flights at the start of the business trip if the leisure leg is first. The user will be presented with incoming and outbound flights for the combined dates. The results of the search for flights home at the end of the business trip or flights out at the beginning of the business trip will be logged in order to carry out the automatic cost-splitting described below, and this second search may be carried out at a later stage in the process. This way, information regarding the selected combined trip can be used to narrow the second search, which is more efficient.

Where additional passengers are to join the trip for the leisure section, additional outbound and incoming flights for these passengers will be searched for and presented. These will be associated with the leisure portion of the trip only for the purposes of cost-splitting. It may be that the system separately searches for 3 return flights, a return flight for the business leg, a return flight for the leisure leg, and a return flight for the combined trip. The return for the combined trip, and the leisure trip in respect of additional travellers if present, will be displayed to the user, and the others executed and/or used during the cost-splitting process.

As mentioned, the search for return flights relating to the business leg only may be carried out fairly late on in the process, such as when the user is about to check-out and pay for the flights in order to carry out the cost comparison. The user has already at this stage selected which flights he or she will take for the combined trip, and the selected dates and time can be used to narrow the search for return flights relating to the business trip only. Return flights with the same outbound (or inbound) flight as the selected trip can be searched, for example. In some embodiments (i.e. if no additional passengers will be joining), only 2 return flights need to be searched, one covering the combined trip dates and one covering the business trip dates. The cost of each of these can be compared during cost-splitting. The same result can be achieved by searching only the leisure trip for the employee and comparing this with the cost of the combined trip. If this is done, then it may not be necessary to search for return flights in respect of the business portion of the trip separately.

Where additional passengers are to be added for the leisure portion, the presented results may be limited, sorted, or highlighted to ensure that all passengers return or depart on the same flight or have the option of doing so (and/or that joining passengers are on the same inbound and outbound flight if there are more than one). The searches for the flights relating to the leisure portion for all travellers may be carried out simultaneously.

As for the hotel searches, the results of the business and leisure searches may be compared, combined, and presented together based on a personalised match score or other criteria used to annotate each result.

The way in which the search results for the different legs of the trip, and/or the combined trip, are compared, and the choice of which results to present to the user will depend on a profile or rule set which is linked to each of the available services and stored on the system. This rule set can be adapted over time, or changed manually, or it can be fixed for each of the services available. In respect of flights, for example, the rule set can specify that where more than one passenger is to be present on the leisure portion of the trip, the return flights (or outbound flights if the leisure portion is first) should be searched for and selected to ensure that all passengers are on the same flight. Flights for additional passengers will generally be searched for together based on the leisure dates, which will most often be the same for all of the one or more additional passengers. The rule set may also include information about how to order the results, i.e. in order of increasing price. The hotel rule set may specify that only hotels which have a room available during both legs of the trip should be presented as options. In some cases, only hotels with a particular type of room available during both legs should be presented. After both searches have been completed (these will usually be executed in parallel), the backend executes an algorithm to combine and compare the two search results, and thus creates a combined result set that includes hotels and their valid room configuration (each room may additionally offer various board options) for both legs of the trip.

In the case where an employee chooses not to stay in the same room, or even the same hotel, for the business and leisure portions of the trip, then the logic is simpler. This will apply to around 20% of cases, for example if the employee wants to stay in a different area of a town for the two portions of the trip. They may also want to minimise costs for the leisure portion, or the company may place some limitations on the type or cost of hotel which can be booked for the business portion and the employee may wish these not to apply for the leisure portion. Around 80% of the time the employee will wish to stay in the same room for both portions of the stay, and this can be accommodated. The “same room” in this case may comprise a room that is in the same hotel, of the same type, and has the same configuration (the same add-ons available etc). Since the system will create two hotel bookings in the background (one for the business dates and one for the leisure dates, assuming no overlap), the hotel booking reference from the first booking (the earliest date range), can be added as a comment to the hotel for the second booking, requesting a continuous stay in the same room. This can be done automatically by the system in some cases.

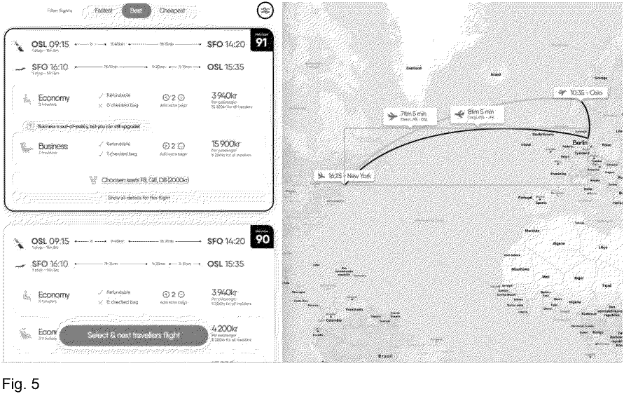

Once the system has processed the data, relevant search results for each bookable category, e.g. flight, hotel, and rental car, are presented. This is done behind the scenes by querying single or multiple databases or external sources or systems based on the search criteria input by the user. FIG. 5 illustrates an example display screen through which a user can select flights for each traveller. Where it is necessary to select from a plurality of different options in respect of one of the services, as many selection options as possible are presented and the selection can be made via a single display screen/interface. The selections for previous options are therefore available and visible whilst choosing selections in respect of the later options, and all can be adapted together until a final confirmation is given. In the case of flight booking these options may include a seat selection, bag selection, and a flight grade/class selection. For the hotel booking, the options may include room type, whether breakfast should be included with the room, check in/out time, and so on. This integrated selection screen in respect of each service makes the process easier and less confusing for the user. Multiple services, along with the multiple options in respect of each, can also be presented on a single screen in some cases. The selection of the various associated options in respect of each of the flights and hotels may be made using the same screen, for example.

Search results may be presented based on a calculated “personal relevance score”, named match score, annotating each search result item. A personal relevance score for each user of the system may be determined based on a machine learning model or other relevant algorithms and techniques which use a previous booking history of the user or associated users as training data. The model will be able to identify with increasing accuracy particular behaviour patterns and decisions, explicit personal preferences, or policies defined by the company. Once the search results for each of the business and leisure portions of the trip have been extracted, these may each be annotated with a score based on certain criteria, and this score can be used to order the search results for presentation to the user.

The results of the various searches may be sorted and displayed based on any one or more relevant parameters such as cost, travel time, distance from airport to hotel, distance from an input address/location (e.g. a conference centre or customer meeting location) to the hotel, the abovementioned personalized match score, and so on. The system may be configured to apply manual or automatic filtering options which modify the search request and redisplay newly generated results. The search results may also be filtered based on the availability of both business and leisure options, or based on rules forming part of the company policy and incorporated into the service rule set, so that the user is guided to select the appropriate bookable options for the combined trip as a whole.

Information including the results of the various searches carried out by the system are presented to the user via a graphical or textual user interface. Information displayed via this interface can include both a list of bookable options and a map view on which each of the options is displayed at a corresponding location. Each bookable option may be displayed associated with images, key information, and detailed information about the option. This information may include hotel room configurations, flight cabin classes, and seat selection.

The system can be tailored to a large extent in order to take into account specific policies of a company using the platform, or can be accessed via the API. Search results presented to the user can be filtered based on company policies, for example, or these can be ordered based on displaying lower price options higher up the list, or displaying hotel options which will minimise travel time/cost once in the destination city first to encourage a user to select these. A maximum cost can be set, and only options with a price point below this can be displayed, or other options can be marked as “out of policy”, or distinguished in some other way from the results which are in policy. In policy options can be highlighted, or presented in a different colour, for example. The employee can also request approval for options that are outside of accepted company policy. Additionally, they can be provided with the option to upgrade (e.g. flight cabin class) as an additional personal expense instead of requesting approval, in which case the system will automatically split the cost according to the company policy between business cost and leisure cost payable by the employee for upgrading.

The way in which the searches are carried out during the booking process ensures that, while to the user the booking process is integrated as a single process, the costs of the separate legs of the trip are readily available to the system. This means that the cost of the leisure and business legs can be separately presented during the confirmation and payment section of the process, as well as during the process of selecting options for each service. The cost of the hotel, flight, activities, restaurant, or car rental, in respect of each of the leisure and business legs and/or the combined dates can be shown separately when results are displayed for selection, for example. Cost-splitting will take into account the difference in cost between the flights that the employee will actually take and has selected, and the flights which they would have taken if the leisure trip had not been added. This is calculated based on the results of the two or three separate searches made behind the scenes, as described above. The cost of the additional travellers’ flights is most often added to the leisure cost, but this may also depend on company policy. The company may choose to cover the travel costs for one additional individual or a percentage of this individual’s additional cost, for example. The hotel cost, similarly, can be split into a cost for the leisure portion and the business portion. Also, if an upgrade choice has been made, either for the flight or hotel selection, the system will split the costs between business and leisure according to company policy.

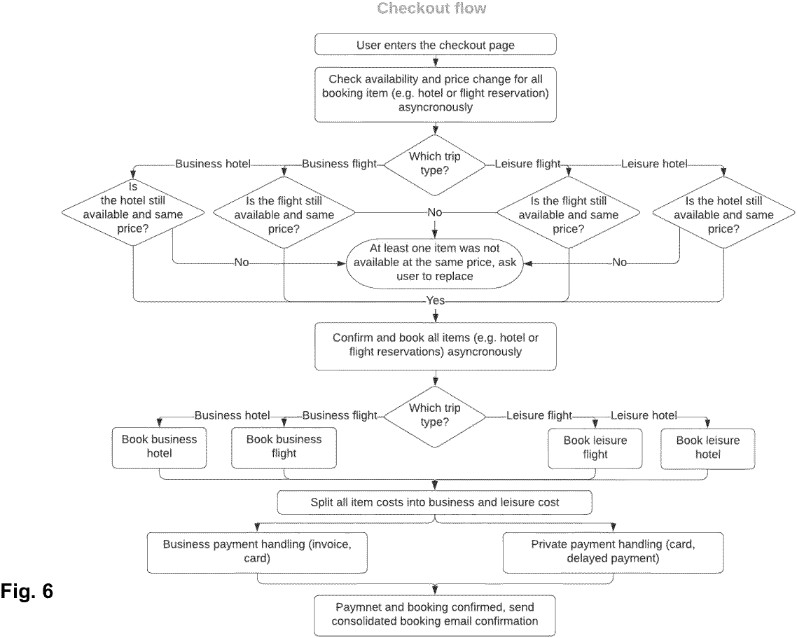

FIG. 6 illustrates the process flow during checkout. The system rechecks the selected options to ensure that these are still available at the same price. If they are, the user is asked to confirm that they would like to book. This confirmation may comprise a single input in respect of all services and options, or may comprise an input per service and/or an input per option. The costs are calculated by the system, using at least in part the results of the previous searches, and are split into a cost for the leisure portion of the trip and a cost for the business portion, which are presented separately.

Different payment options may be used to pay for each of the business and leisure portions of the trip. This way the user can easily pay for the leisure portion of their trip using their personal debit or credit card, and charge the business portion of the trip to the company via a company credit card, an invoice, or the same personal credit card for subsequent expensing to the company. Options for delaying costs may also be provided, so that the employee can defer payment of their portion of the cost until a later date. The process of expensing the business costs will be made much simpler and much more visible to employers. The option of using vouchers or accrued points may also be available, and these options may vary depending on whether they are in respect of the leisure or the business portions of the trip, and can be set according to the company policy rules accessed by the system. The details of the costs and payments will be stored on the company-based booking platform, and receipts indicating the cost of the different legs and separate cost break-downs can be provided. This makes the whole process of booking combined business and leisure trips much less complex, at least to the user, who experiences one single integrated process. The user can click once only to confirm the two separate payment transactions (for each of the business and leisure costs), and both transactions will be carried out separately as a result. Payment details may be pre-filled with a default in respect of each leg or may be filled in by the user as part of the process. Alternatively, two separate confirmation inputs can be required, one in respect of each transaction.

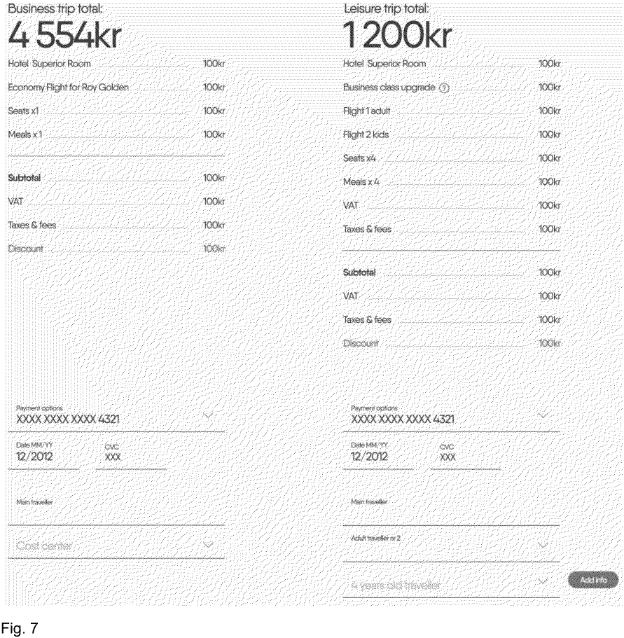

An example of a payment confirmation screen is shown in FIG. 7. Here, the costs of the separate legs of the trip are displayed next to one another on a single screen and a single confirmation is required to pay for both portions. The payment methods for each of the different portions may be different. In the example shown a payment card with a number ending 4321 will be used to pay for the business trip (or costs relating to the business trip which the company agrees to pay according to their policy) and the same card in respect of the leisure portion of the trip (the remainder of the cost). Alternatively, an email for an invoice to be forwarded in respect of the leisure portion of the trip. Alternatively, a different card may be used to pay for the business and leisure portions.

Once the user confirms the booking and indicates that they are ready to pay for the selected booking options, the system will execute individual bookings for the different booking options automatically, so that business and leisure bookings are kept separate. As an example, if the user has chosen to extend a business trip with a leisure stay and has opted to bring along a partner, the total booking will comprise two hotel bookings (one for the employee covering business dates and one for both travellers covering the leisure dates) and two flight bookings (one for the employee covering the combined dates and one for the additional travellers covering the leisure dates). For the end user it will be presented as only one single booking and will generally require only one confirmation, while the system actually performs multiple bookings behind the scenes. This greatly simplifies the booking experience for the user. This also enables the possibility of editing or cancelling multiple bookings simultaneously, e.g. either the single “master” booking (including all of the individual bookings), or the hotel booking (comprising both business and leisure hotel bookings), or the flight booking (comprising both business/combined and leisure bookings), or any individual booking can be amended or cancelled. This provides a very high degree of ease and flexibility for the end user.

The travel booking platform can also be integrated end-to-end with the accounting platform, and more specifically with an expense management platform, used by a customer company in order to facilitate the expensing process for expenses payed using a personal payment method. In some cases, this can allow company policy rules to allocate a specific budget (i.e. a monthly, quarterly, or yearly budget) to be used to cover part of the leisure cost for an employee. This can be offered by the company to the employees as a perk or as a talent retaining scheme. Payment options may also be presented based on company policy, and accessed by the system as part of the company policy information. Once options for both the leisure and business portions of the trip have been selected, these may be automatically expensed using payment options that have been approved by the company.

The system may allow the employer to maintain an overview of all active and upcoming business trips by the use of booking data. The results can be presented in any way, such as on a map or in listing view. Authorized representatives of the company are able to view this information and provide relevant support if needed. This could mean initiating mass communication (e.g. SMS or email) to all travellers or to travellers currently located within a particular limited region, etc.

The platform can also comprise third-party solutions used by the employers to receive the same business booking information via another means if desired.

An external service and database can be integrated, which can provide an updated, and in some cases real-time, risk assessment and/or event notification for specific areas. Using this information, it is both possible to inform/warn the employee at booking stage about potential risks (also the company policy might restrict booking options based on a risk level) as well as while they are travelling.

The system may also include the process of comparing one booked option to another bookable option and determining a cost difference. This way even more granular cost splitting options may be applied. Specifically, this includes comparing a flight option for an extended leisure stay with the comparable option for the business start or end, so that the separate cost of each of the two options can be determined and allocated to the appropriate party (e.g, leisure/private costs at least partially allocated to the employee themselves). The employee can also be presented with the option of upgrading their travel to a more expensive option in respect of one or more services. This additional cost can be allocated to the part of the budget payable by the employee (i.e. to the leisure budget). The additional cost is determined by comparing the selected option to a maximum cost that the company is willing to cover based on their company policy rules.

As an example, the system can compare a selected flight option with another relevant flight option on the relevant business date (start or end) based on one or more of the following criteria: Same cabin class, same airports, same max number of layovers/segments, no low cost airlines, relevant time period (e.g. afternoon/evening after 6PM for a return flight or morning before 9AM for an outbound flight). If the traveller wants to extend the trip from Friday (end of business trip) to Sunday (end of combined/leisure trip), for example, the system will compare the Sunday tickets to the cheapest Friday flight based on the above criteria. More specifically, this is done by executing a new flight search with the above criteria for the relevant direction (outbound or inbound) and comparing one of the search results (i.e. the cheapest, or the most expensive that is still within company policy). The cost difference may be fully or partly allocated to the leisure cost to be covered privately based on the company policy rules. The first and second availability searches are in this case searches for the return flight at the end of the leisure/combined trip and the return flight on the Friday (which would have been taken if the leisure trip were not included). A single flight can be searched, or a return flight including an outbound flight at the start of the combined trip.

Once the process is complete, the system can send a combined booking confirmation to the user e.g. via app notification, email, or a text message. Tickets may also be sent to the user in this way. Separate emails with business and leisure invoice information may be sent, so that only the business costs are visible for the expensing process or to company representatives.

What is claimed is:

1. A travel management system configured to:
accept, as input, selected dates for the start and end of a business portion of a trip and the start and end of a leisure portion of a trip;
accept, as input, service data for each of one or more services;
for each of the one or more services, access an associated rule set and conduct a first availability search based on the service data in respect of a first pair of the input dates that is selected based on instructions in the rule set;
and select one or more of the results of the first availability search for display to a user.

2. The travel management system of claim 1, wherein the travel management system is configured to accept personal input data for each of one or more persons.

3. The travel management system of claim 1, wherein the service data comprises service type, and optionally at least one of service place, service owner, and service share information.

4. The travel management system of claim 3, wherein
the service type is one of transport, accommodation, restaurant, experience, and “event”;
the service place is a combined departure and destination, or a “location”;
the service owner is person, a group or a company,
and the service share information is a specification of other of the one or more persons with whom the service should be shared.

5. The travel management system of claim 1, wherein at least a subset of the service input data is selected commonly for more than one of the one or more persons.

6. The travel management system of claim 1, configured to perform a second availability search in respect of another of the input dates or in respect of a second pair of the input dates selected based on instructions in the rule set.

7. The travel management system of claim 6, wherein the first and second availability searches are carried out in response to the user providing a single search confirmation to the system.

8. The travel management system of claim 6, wherein the first pair of dates are the start and end dates of the combined trip or the start and end dates of the leisure portion of the trip, and the second pair of dates are the start and end dates of the business portion of the trip.

9. The travel management system of claim 6, wherein the rule set comprises an instruction to compare the results of the two availability searches and to select and display or highlight only those results which are present in both.

10. The travel management system of claim 6, wherein the first pair of input dates are the start and end dates of the leisure portion of the trip and the second pair of input dates are the start and end dates of the business portion of the trip, and the results displayed include the results of both searches.

11. The travel management system of claim 10, configured to accept as input the selection of one or more of the results displayed after the search stage, and to carry out one or more bookings relating to the leisure portion of the trip, and one or more bookings relating to the business portion of the trip in response to a single booking confirmation input, or one single booking covering the leisure and business portion of the trip in response to a single booking confirmation input.

12. The travel management system of claim 6, wherein the one or more services comprises an accommodation service, the first availability search is a search for accommodation with available during the leisure portion of the trip and the second availability search is a search for accommodation available during the business portion of the trip.

13. The travel management system of claim 6, wherein the one or more services comprise a transport service, the first availability search is a search for return transport with an outbound journey on the first day of the combined trip and a return journey on the last day of the combined trip, and the second availability search is a search for return transport with an outbound journey on the first day of the business portion of the trip and a return journey on the last day of the business portion of the trip.

14. The travel management system of claim 13, wherein the rule set comprises instructions to execute the first availability search and display one or more of the results of the first availability search to the user, to wait for selection of a result by the user, and to execute the second availability search only in respect of return transport which have one journey in common with the selected result.

15. The travel management system of claim 14, wherein the user input comprises the details of one or more additional travellers for the leisure portion, the system is configured to carry out a third availability search for return transport with an outbound journey on the first day of the leisure trip and a return journey on the last day of the leisure trip, and the flight rule set comprises instructions to display or highlight only the results of the first and third availability searches which include one journey in common.

16. The travel management system of claim 1, wherein the system is configured to present a single payment confirmation screen displaying the separate costs of the business and leisure portions of the trip, including the cost of each of the one or more services, and at least one confirmation icon for confirmation payment of one or more portions of the trip.

17. The travel management system of claim 1, wherein the system is configured to access cost policy information specifying a proportion of the leisure trip to be covered by the company, and to separately display a cost payable by the employee and a cost payable by the company for the combined trip on a single payment confirmation screen with at least one confirmation icon for confirmation of payment of the portion payable by the employee and/or by the company.

18. The travel management system of claim 16, wherein the payment confirmation screen comprises a single confirmation icon for confirming payment of both portions.

19. The travel management system of claim 1, wherein the rule sets for each of the one or more services are stored in a database comprised as part of the system.

20. The travel management system of claim 19, wherein the rule sets for each of the one or more services are updated based on a user input or based on previous selections made by the user.

21. The travel management system of claim 1, wherein the system is configured to edit or cancel one or more of the services relating to both the business portion and the leisure portion of the trip in response to a single user request to edit or cancel the one or more services for the combined trip.

22. A travel management system configured to:
accept, as input, selected start and end dates for two or more portions of a trip;
accept, as input, service data for each of one or more services;
for each of the one or more services, conduct at least two availability searches based on the service data in respect of at least two respective pairs of the input dates;
select one or more of the results of the at least two availability searches for display to a user; and
based on selected results and in response to a single booking confirmation input, complete at least one booking in respect of the first pair of dates and at least one booking in respect of the second pair of dates.
